(19) United States
(12) Patent Application Publication
(10) Pub. No.: US 2018/0260366 A1
(43) Pub. Date: Sep. 13, 2018

(54) INTEGRATED COLLABORATION AND COMMUNICATION FOR A COLLABORATIVE WORKSPACE ENVIRONMENT

(71) Applicant: Microsoft Technology Licensing, LLC, Redmond, WA (US)

(72) Inventors: Michael A. Brasket, Kirkland, WA (US); Robertjan Tuit, Seattle, WA (US); Sourabh Kukreja, Woodinville, WA (US); Hugh A.P. Eland, Praha (CZ); Mark I. Rubinstein, Seattle, WA (US); David M. Phillips, Kirkland, WA (US); Vivian Hsu, Seattle, WA (US)

(73) Assignee: Microsoft Technology Licensing, LLC, Redmond, WA (US)

(21) Appl. No.: 15/625,808

(22) Filed: Jun. 16, 2017

Related U.S. Application Data
(60) Provisional application No. 62/468,844, filed on Mar. 8, 2017.
(60) Provisional application No. 62/469,390, filed on Mar. 9, 2017.

(51) Int. Cl. G06F 17/21; G06F 3/0484

(52) U.S. Cl. CPC G06F 17/218; G06F 3/0482; G06F 3/04842

(57) ABSTRACT

Described herein is a user interface that enables individuals that access a collaborative workspace environment to add subsections to a workspace in a canvas and provide and associate tagging notifications to the various subsections of the workspace. Further, the user interface includes another canvas that displays the tagging notifications and any associated text. Thus, any comments, text, or other content that is provided in the tagging notification is also reflected in the second canvas—regardless of which subsection the messages pertains to.

### CROSS-REFERENCE TO RELATED APPLICATIONS

This application claims priority to U.S. Provisional Patent Application No. 62/468,844 entitled “Integrated Collaboration and Communication for a Collaborative Workspace Environment”, filed on Mar. 8, 2017 and to U.S. Provisional Patent Application No. 62/469,390 entitled “Integrated Collaboration and Communication for a Collaborative Workspace Environment”, filed on Mar. 9, 2017, the disclosures of each of which are hereby incorporated by reference in their entireties.

### BACKGROUND

In current collaborative workspace environments, different users may draft documents and notes, share thoughts and ideas and so on. However, there is currently no mechanism whereby the various users of the collaborative workspace environment are able to specify individual portions of the documents, notes or share ideas about the documents or notes in real time or substantially real time.

It is with respect to these and other general considerations that examples have been described. Also, although relatively specific problems have been discussed, it should be understood that the examples should not be limited to solving the specific problems identified in the background.

### SUMMARY

This disclosure generally relates to a system and methods for enabling a user that accesses a collaborative workspace environment to have conversations about a subsection of a workspace (also referred to herein as a document) in real time or substantially real time. Further, an individual that accesses the collaborative workspace environment may “at-mention” another individual, tag another individual or user to draw that individual's attention to the specific section, or subsection of the workspace. Further, any conversations about a section or subsection of the workspace may be propagated to a conversations tab or other such canvas that is viewable by other individuals that access the collaborative workspace environment.

More specifically, described herein is a system comprising at least one processing unit and at least one memory storing computer executable instructions that, when executed by the at least one processing unit, causes the system to perform a method. The method includes displaying a first canvas associated with an entity. The first canvas hosts or otherwise displays a document that is dividable into subsections. Subsections may be added to the document in response to a received input. A tagging notification may be received and associated with the subsection of the document. In some examples, the tagging notification identifies an individual that has access to the document in the collaborative workspace environment. The tagging notification may also be provided on a second canvas in the collaborative workspace environment. A notification of the tagging notification may then be provided to the individual.

Also described is a method that includes displaying a first canvas on a user interface of a computing device, wherein the first canvas is associated with an entity and hosts a document that is dividable into subsections. A subsection may then be added to the document in response to a received input. Content may also be added to the subsection of the document in response to additional received input. A tagging notification may be associated with the subsection of the document, wherein the tagging notification is directed to an individual that has access to the subsection of the document in the collaborative workspace environment. The tagging notification may also be displayed on a second canvas in the collaborative workspace environment and a notification of the tagging notification may be provided to the individual.

The present application also describes a system that includes at least one processing unit and at least one memory storing computer executable instructions that, when executed by the at least one processing unit, cause the system to perform a method. The method includes displaying a canvas associated with an entity in a user interface of a collaborative workspace environment and creating a workspace in the canvas in response to received input. A subsection may be added to the workspace in response to received input. Once the workspace is created, a tagging notification that identifies an individual that has access to the workspace may be generated and associated with the subsection. The tagging notification may also be provided on a second canvas in the user interface. A notification of the tagging notification may then be provided to the individual.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for providing a collaborative workspace environment.

FIG. 2 illustrates an example user interface for a collaborative workspace environment in which a workspace may be dividable into subsections.

FIG. 3 illustrates the example workspace of FIG. 2 in which a new subsection has been added.

FIG. 4 illustrates how a tagging notification can be provided to a workspace of the collaborative workspace environment.

FIG. 5 illustrates that the tagging notification is associated with a subsection of a workspace in the collaborative workspace environment.

FIG. 6 illustrates an example conversation canvas of the collaborative workspace environment.

FIG. 7 illustrates that rich content may be added to a subsection of a workspace of the collaborative workspace environment.

FIG. 8A and FIG. 8B illustrates how content from the conversation canvas of FIG. 6 can be quoted in a subsection of the workspace of the collaborative workspace environment.

FIG. 9 illustrates various operations that may be performed on a subsection of a workspace of the collaborative workspace environment.

FIG. 10 illustrates a comments pane that may be associated with a subsection of a workspace of the collaborative workspace environment.

FIG. 11 illustrates how multiple individuals may edit different subsections of a workspace of the collaborative workspace environment.

FIG. 12 is a block diagram illustrating example physical components of a computing device with which aspects of the disclosure may be practiced.

FIG. 13A and FIG. 13B are simplified block diagrams of a mobile computing device with which aspects of the present disclosure may be practiced.

FIG. 14 is a simplified block diagram of a distributed computing system in which aspects of the present disclosure may be practiced.

FIG. 15 illustrates a tablet computing device for executing one or more aspects of the present disclosure.

### DETAILED DESCRIPTION

In the following detailed description, references are made to the accompanying drawings that form a part hereof, and in which are shown by way of illustrations specific examples or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The disclosure generally relates to a user interface for a collaborative workspace environment. In general, the collaborative workspace environment displays or otherwise provides a user access to multiple groups in the collaborative workspace environment. Each group may have one or more channels or contexts and each channel or context has a workspace in which content or an entity may be displayed and/or shared with other members of the group. Each member of the group, may access, edit, comment, post or otherwise interact with the entity that is displayed in the workspace.

As used herein, a context may refer to a tenant in a multi-tenant environment, a team, a channel, a topic, etc. Additionally, as used herein, the term entity means an item within or otherwise provided by service. The entity may be a document, a task, a board and other such content provided by a service. Further, the term entity and content may be used interchangeably. The term service may be any product that provides content. For example, a product may be a word processing application, a workflow management application and so on. The service may be a third party service or a local service that the collaborative workspace environment has access to. Once an entity is provided in the workspace, each member of the group or users that access the context, may access, edit, comment, post or otherwise interact with the entity.

The user interface includes contextual canvases that are associated with each context. Canvases in each of the contexts may be added, removed and edited. When a canvas is selected, a workspace (e.g., a document) associated with the canvas is created and/or provided on the user interface. In some examples, a canvas is associated with or hosts a particular entity from a service.

In some examples, the workspace (also referred to herein as a document) may be dividable into different subsections. As such, each individual that accesses the collaborative workspace environment can add a new subsection to the document. Once the subsection is added, the individual may add content to the subsection.

In some examples, an individual may use tagging notification to tag a particular individual or individuals in order to direct that individual's attention to a particular subsection of the workspace. In some cases, the tag may be an “at-mention” notification. In other examples, the tag may be some other type of identifier or notification mechanism that is used to alert or otherwise notify the individual that has been tagged that their attention to a particular subsection of the document is needed. Once the tagging notification has been associated with the subsection of the document, a notification is sent to the individual that was mentioned or tagged in the tagging notification.

The tagging notification may also include comments or text provided by the individual that created the tagging notification. These comments may also be provided in a conversation canvas of the collaborative workspace environment. In some examples, the conversation tab is a portion of the user interface that is viewable by every individual that accesses the entity of the collaborative workspace environment. When an individual selects the tagging notification provided in the conversation tab, the user interface of the collaborative workspace environment displays the subsection of the document that is associated with the tagging notification. Thus, an individual may navigate directly to the subsection of the document that was identified in the tagging notification.

In yet other examples, the document, or different subsections of the document, may be locked for editing. In some cases, the subsection is locked automatically in response to input being received in the particular subsection. Thus, when one individual of the collaborative workspace environment is adding, deleting and/or editing content in one of the subsections, other individuals that have access to the document cannot make changes to that subsection. However, the second individual may edit a different subsection and that subsection will also be locked in the manner described above.

In still yet other examples, a link can be created and associated with each subsection of the document. The link may then be shared with other individuals that access the collaborative workspace environment. When the link is selected, the user interface of the collaborative workspace environment displays the subsection associated with the link.

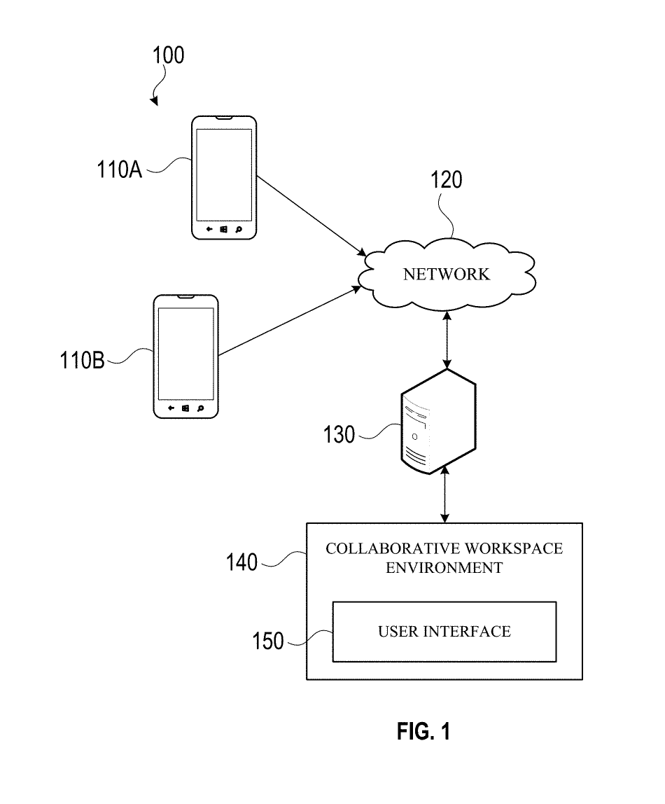

These and other examples will be explained in greater detail below with respect to FIG. 1-FIG. 11.

FIG. 1 illustrates an example system 100 for providing a collaborative workspace environment 140 according to one example. In aspects, one or more client devices, such as for example, client device 110A and client device 110B may access a network 120, or other internet connection, and access the collaborative workspace environment 140 executing on a server computing device 130.

In some examples, each of the client computing devices 110A and 110B are personal or handheld computer having both input elements and output elements. For example, the client computing device 110A and the client computing device 110B may be one of: a mobile telephone; a smart phone; a tablet; a phablet; a smart watch; a wearable computer; a personal computer; a desktop computer; a laptop computer; a gaming device/computer (e.g., Xbox); a television; and the like. This list is for example purposes only and should not be considered as limiting.

The system 100 is a communication system/service that provides the collaborative workspace environment 140 for users to communicate and collaborate over the network 120. In an example, the collaborative workspace environment 140 provides a configurable and extensible workspace for collaboration between individuals through a user interface 150 that may comprise a plurality of different views.

Users of the collaborative workspace environment 140 may include but are not limited to: one or more persons, companies, organizations, departments, virtual teams, ad-hoc groups, vendors, customers, third-parties, etc. The collaborative workspace environment 140 enables visibility and communication between users including users who are organized in teams or groups as well as users/groups outside of a team/group.

More specifically, when a user accesses the collaborative workspace environment 140, the user may have access to one or more groups. Each group may be associated with various contexts that have a particular set of entities or other content. One or more canvases are associated with each context and each canvas has an associated workspace or document in which an entity, that is related to or otherwise filtered for the canvas and/or the context is displayed. By selecting the various canvases that are displayed, different entities, associated with each canvas, is provided in the workspace.

In some instances, each canvas may be used to provide an entity that multiple users may access, edit, and/or create. In one example and as will be described below, a canvas may provide or otherwise host a workspace or a document that may be editable by various members of the group. Additionally, the document may be dividable into various subsections. Further, rich content may be added to each subsection.

In some examples, one or more members of the group may direct the attention of the other members of the group to a particular subsection of the document using a tagging notification. When the tagging notification is associated with a particular section, the individual or member of the group that is the subject or target individual of the tagging notification is notified. Although one (or more) individuals may be the subject or target of the tagging notification, other members of the group may also view the tagging notification as well as any content associated with the tagging notification.

The entity may be provided by various services—both local services (e.g., services, applications and products provided or otherwise hosted by the server 130) and external or third party services. Example services include, but are not limited to, word processing applications or services, spreadsheet applications or services, line-of-business (LOB) management services, customer relationship management (CRM) services, debugging services, accounting services, payroll services and so on. In other examples, the entity associated with each canvas may include content from websites and/or applications, such as social media or networking websites, photo sharing websites, video and music streaming websites, messaging applications, search engine websites, sports, news or entertainment websites, and the like.

In some instances, these services may provide robust reporting, analytics, data compilation and/or storage service, etc., whereas other services may provide search engines or other access to data and information, images, videos, document processing and the like.

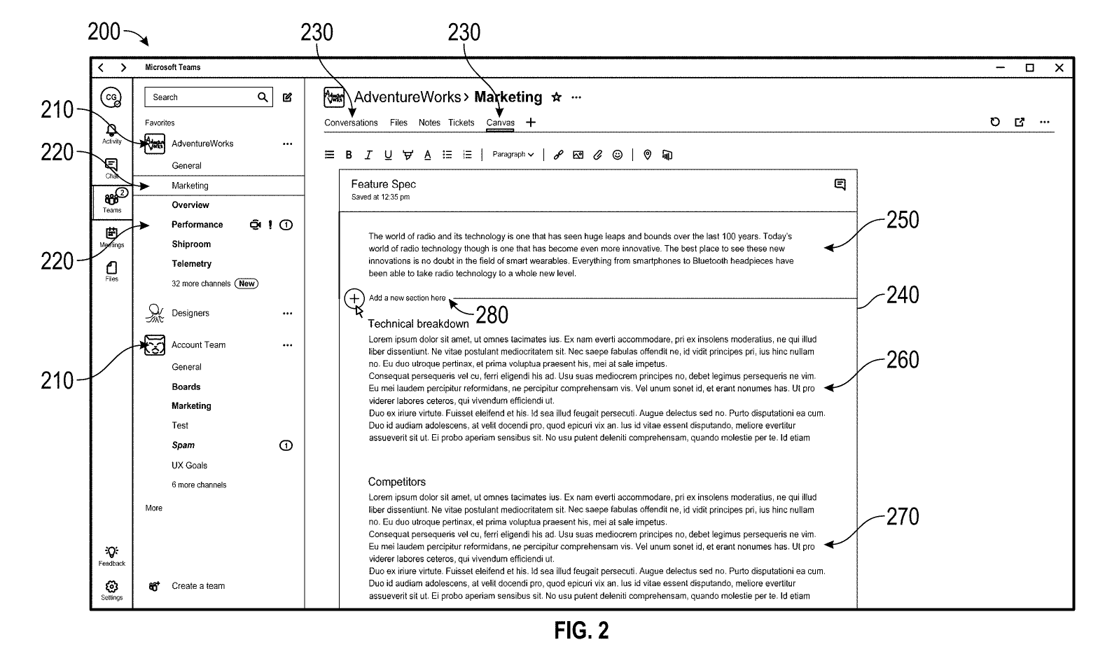

FIG. 2 illustrates an example user interface 200 of a collaborative workspace environment (e.g., the collaborative workspace environment 140 of FIG. 1). The user interface 200 may be similar to the user interface 150 described above in FIG. 1.

In aspects, the user interface 200 shows various groups 210. Each group 210 may be associated with multiple members or individuals. In addition, each group 210 may include one or more contexts 220. For example, the “AdventureWorks” group includes a “General” context, a “Marketing” context, an “Overview” context, a “Performance context” context and so on. Likewise, the “Account Team” group includes a “General” context, a “Boards” context, a “Marketing” context and so on. Each of the groups and contexts shown are for example purposes only.

Once a particular context 220 is selected, various canvases 230 and other tabs associated with the context 220 are provided in the user interface 200. The canvases 230 are used to display entities that have been selected, created or filtered for each canvas.

In this example, the AdventureWorks Marketing channel 220 includes various tabs and canvases. Tabs may be specific to a particular channel and are used to display content similarly to a canvas. In some cases, each individual can create or add new channels and tabs.

As shown, the AdventureWorks Marketing channel 220 includes a “Conversations” tab, a “Files” tab, a “Notes” canvas, a “Tickets” tab and a “Canvas” canvas. Each canvas 230 is associated with a workspace 240. The workspace 240 (also referred to herein as a document) provides or otherwise displays an entity or other such content. For example, the workspace 240 of the present example includes a document named “Feature Spec.” As shown, this particular document or workspace 240 includes content.

Further, the workspace 240 is divided into various subsections. In this example, the workspace 240 includes a first subsection 250, a second subsection 260 and a third subsection 270. In the examples shown, each subsection may include a title (e.g., subsection 260 has a title “Technical Breakdown”) and associated content.

In some examples, a member or individual of the group that accesses the workspace 240 in the particular canvas 230 may add additional subsections. For example, when an individual selects icon 280, that individual may add a new subsection at the selected area.

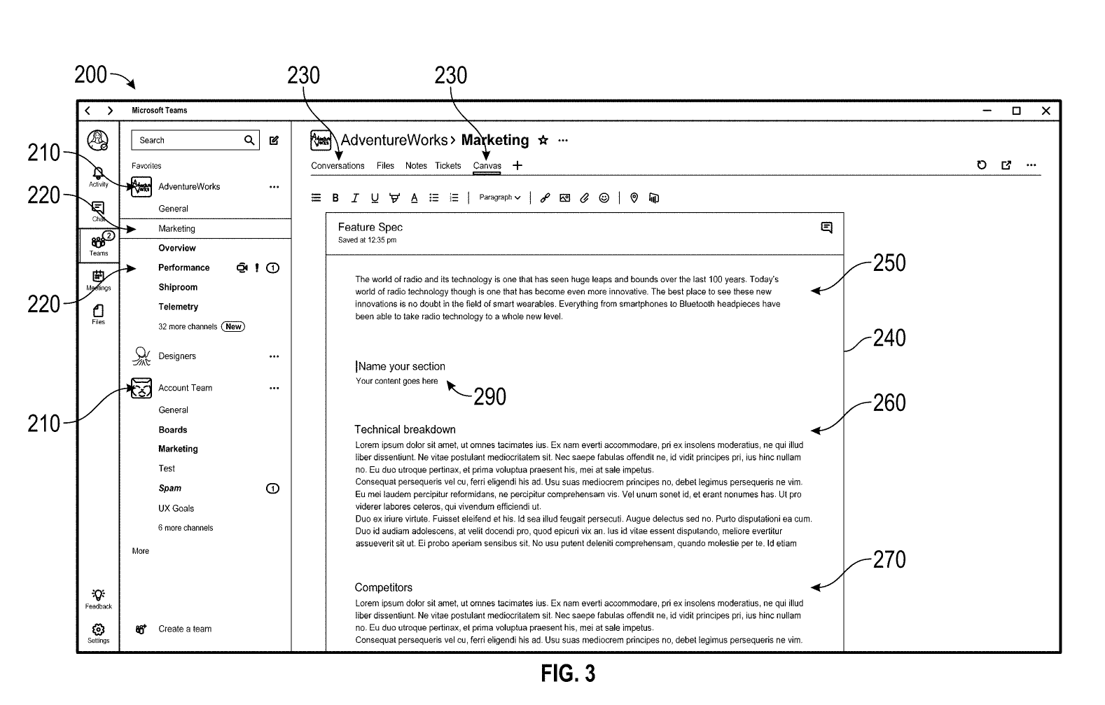

This is further shown in FIG. 3. For example, when the individual selects icon 280, a new subsection 290 is provided above the “Technical Breakdown” subsection 260. The individual may name the subsection and add content to the newly created subsection. In some cases, the content may be text content, image content, video content and the like.

The collaborative workspace environment of the present disclosure also enables one individual that accesses the collaborative workspace environment to tag or otherwise provide a notification to one or more other individuals that access the collaborative workspace environment. In some cases, the tagging notification may be an at-mention notification or other such notification mechanism that enables one individual to direct another individual's attention to a particular subsection of the workspace. In some cases, the tagging notification may be provided directly in a workspace and may be directed at a particular individual or group of individuals that have access to the group, a canvas, an entity and so on.

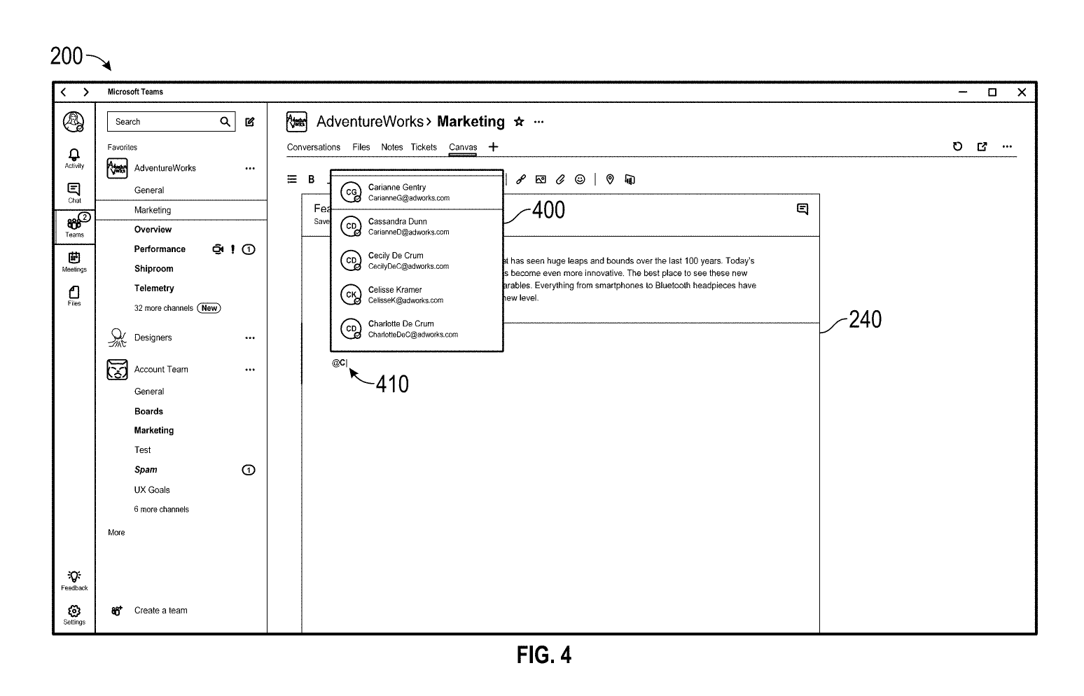

For example, and turning to FIG. 4, when an individual accesses a particular workspace 240, the individual may add a tagging notification to a particular subsection of the workspace 240. In some cases, the tagging notification may be generated when an individual that is creating the tagging notification inputs an at sign “@” (or some other symbol or identifier) followed by the name or identifier of the individual (or individuals) for which the tagging notification is intended for.

When a letter, number or symbol follows the at sign, a list 400 of group members (or other individuals that have access to the collaborative workspace environment or the particular canvas associated with the workspace) may be displayed. The individual that is creating the tagging notification may select the desired individual (or individuals) from the list 400 or may completely enter the individual's name or other identifier (e.g., phone number, nickname, email address, screen name, user name etc.) associated with the individual.

For example and as shown in FIG. 4, the individual that is generating the tagging notification provided input 410 of “@c” in the workspace 240. In response to this input, a list 400 containing individuals in the group whose name starts with a “c” is populated and provided to the individual that provided the input 410.

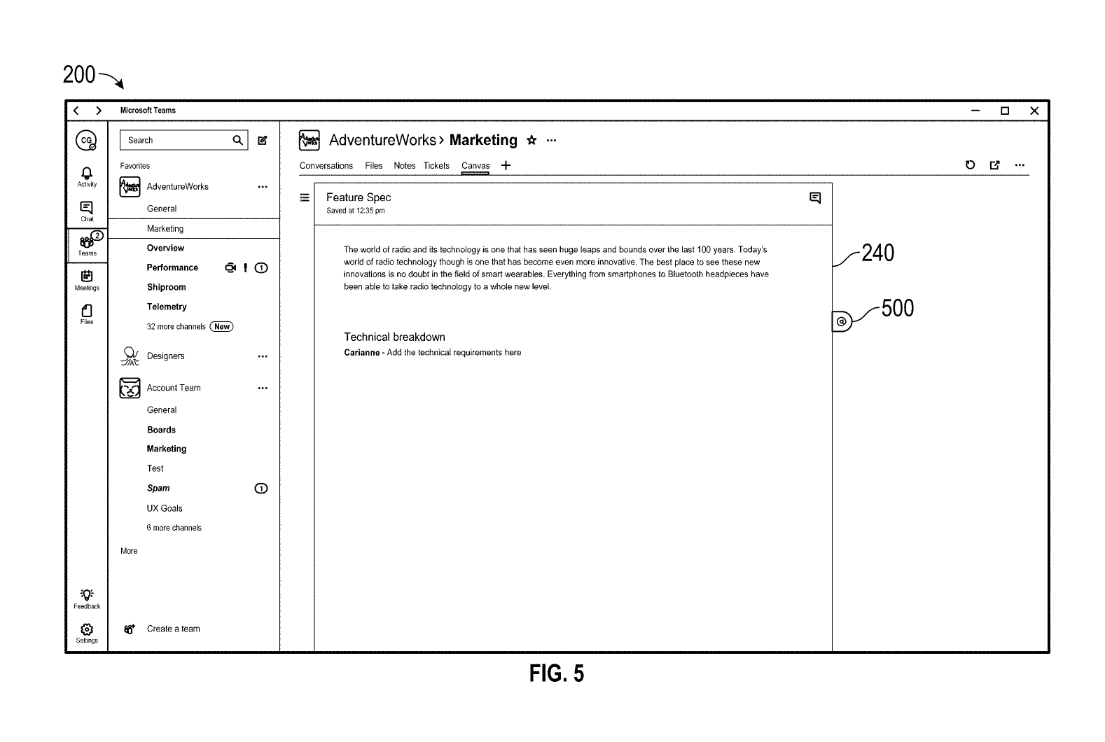

Once the target individual for the tagging notification is identified, the individual that created that tagging notification may add content to the tagging notification. For example and turning to FIG. 5, Carianne is identified as the target individual for the tagging notification. Additionally, the text “Add the technical requirements here” has been added to the tagging notification. As also shown in FIG. 5, once a tagging notification is created, an identifier 500 (e.g., a tagging identifier or other icon) is added to the workspace 240. In some examples, the tagging notification and its associated tagging identifier 500 is associated with a particular subsection of the workspace 240. Thus, in this example, the tagging notification and its associated tagging identifier 500 are associated with the “Technical breakdown” subsection of the workspace 240.

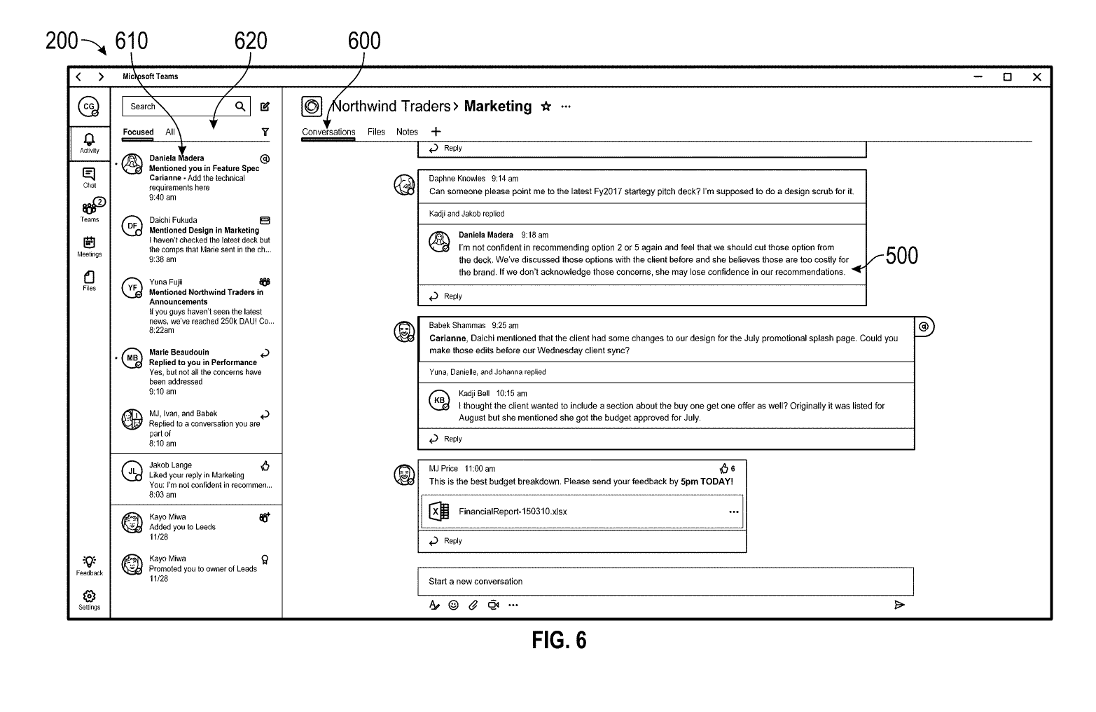

Once the tagging notification has been generated, the individual that is identified as the target of the tagging notification is notified. In some cases, the notification may be provided to the individual in a notification pane (e.g., notification pane 620 of FIG. 6) of the collaborative workspace environment. In other implementations, the individual may be notified about the tagging notification via electronic message (e.g., text message, email and so on), phone call, voice memo and the like.

In some examples, any comments that are made or otherwise associated with the tagging notification, along with the tagging notification itself, may also be provided on a conversations tab 600. For example and as shown in FIG. 6, when a tagging notification is provided on one canvas or tab, the tagging notification and/or any additional comments or other such content associated with the tagging notification are also provided on a conversations canvas such as shown. Further, any comments made in the conversations tab may also be reflected in the text or comments associated with the tagging notification on the canvas or tab on which the tagging notification was originally created and/or presented. Thus, comments, text, content and the like that are made on one canvas or tab may be reflected in another canvas or tab.

As previously discussed, the user interface 200 may also notify the individual that they have been associated with or otherwise targeted by a tagging notification. As also shown in FIG. 6, the notification 610 may be provided in a notification pane 620 of the user interface 200. In this example, the notification states that the creator of the tagging notification “mentioned you in Feature Spec.” The notification 610 may also provide the comment, text or other content that is associated with the tagging notification. In this example, the text “Add the technical requirements here” is provided with the notification. As shown, this is the same text that was provided with the tagging notification from FIG. 5.

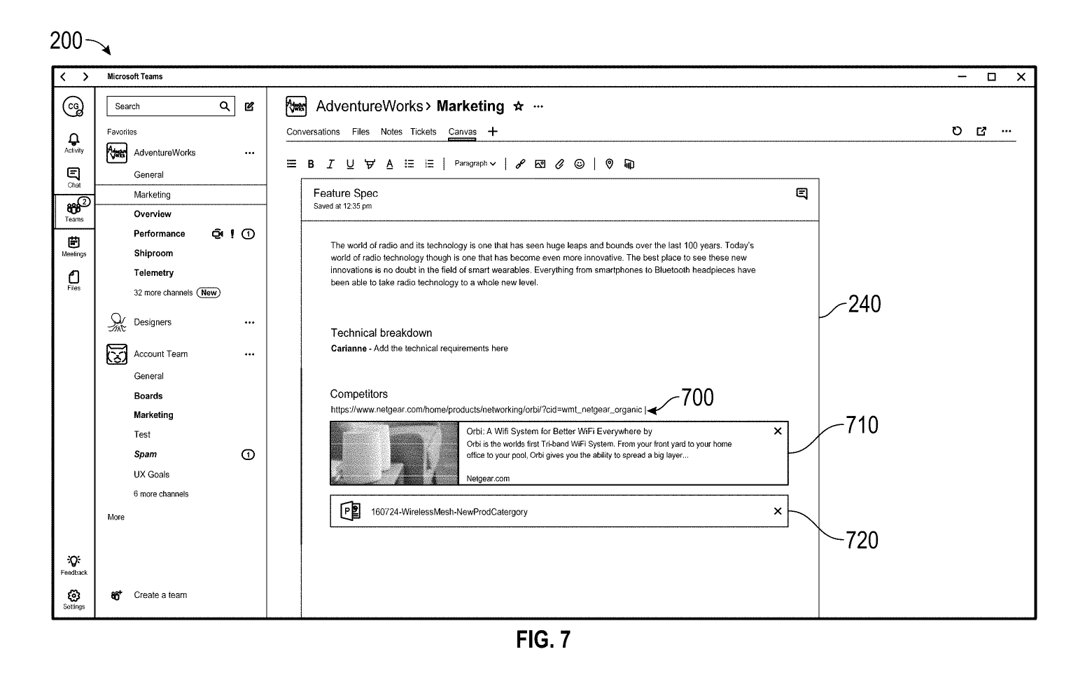

The collaborative workspace environment also enables members of the group to add rich content to a workspace. More specifically, rich content may be added to different subsections of a particular workspace. For example and referring to FIG. 7, the workspace 240 of the collaborative workspace environment may enable various members of the group to add links (e.g., link 700), messages, images (image 710), files (e.g., file 720) and the like to one or more subsections of the workspace 240.

In yet other examples, content that is contained on one tab or canvas may be copied and provided on another canvas and/or associated with a particular subsection in a workspace 240. In some cases, the content may be automatically associated with a tagging notification provided or otherwise associated with a subsection of a workspace.

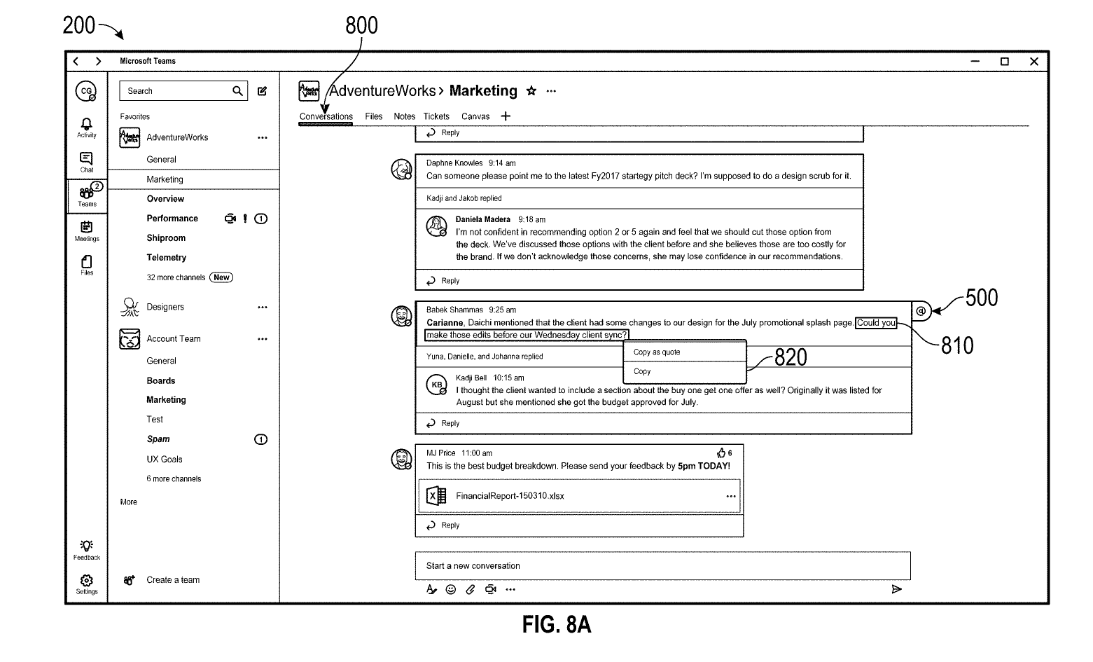

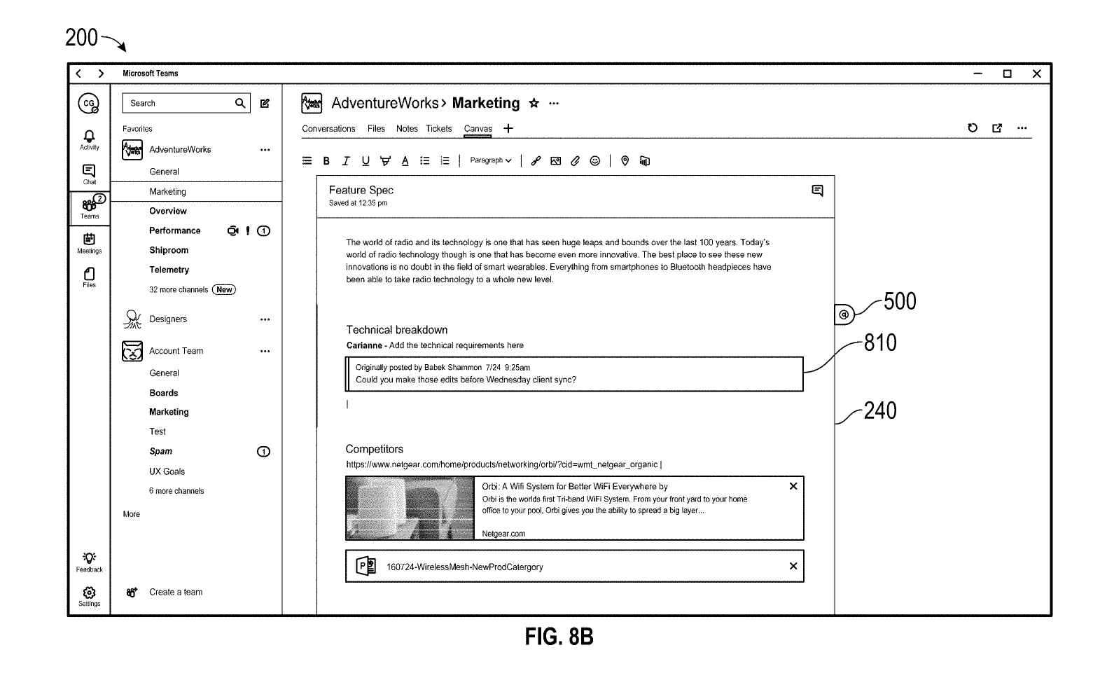

In some instances, content may be provided on a “Conversations” tab 800 such as shown in FIG. 8. The “Conversations” tab 800 may include content, comments, images and the like from various other canvases. Comments and other content that is provided on the “Conversations” tab 800 may be provided on or otherwise propagated to various other tabs or canvases that are associated with a particular group. Likewise, comments, content and the like that are provided on other tabs or canvases may also be shown on the “Conversations” tab 800.

For example, an individual may select a portion of the content that is provided on the “Conversations” tab 800 and cause the selected portion to be provided on a subsection of a workspace 240. As shown in FIG. 8, an individual has selected a portion 810 of displayed content and has selected a “Copy as quote” selection from a menu 820. The selected portion 810 may then be provided on a subsection of a workspace.

For example and as shown in FIG. 8B, the selected portion 810 of the content shown in FIG. 8A, has been placed in the subsection “Technical breakdown” of the workspace 240. In some instances, the selected portion 810 is automatically associated with a particular subsection based on a tagging notification.

For example, as shown in FIG. 8B, the Technical breakdown subsection of the workspace 240 is associated with a tagging notification 500. Likewise, that tagging notification 500 was associated with the selection portion 810 of the text shown on FIG. 8A. Thus, when an individual requests to copy the selected portion 810 as a quote, the selected portion 810 may be automatically associated with the subsection of the workspace that is associated with the same tagging notification 500.

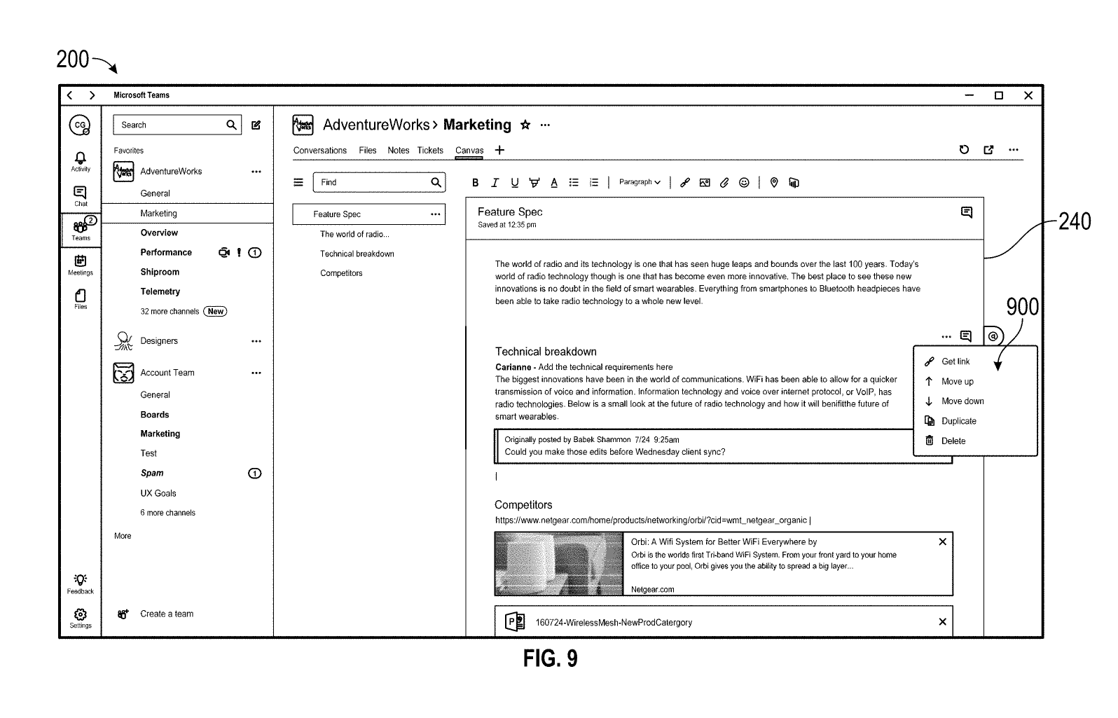

In some examples, various operations may be performed on each subsection of the workspace in the collaborative workspace environment. These include generating a link to a particular subsection in the workspace 240, moving the position of the subsection (e.g., either up or down depending on its current position), duplicating the subsection, deleting the subsection and so on. As shown in FIG. 9, these operations may be provided in a menu 900 that is associated with the subsection.

In cases in which the “Get link” option is selected, a link for the subsection may be generated and subsequently provided to other individuals in the group. For example, the link may be emailed to various members or group, placed in a conversations tab of the collaborative workspace environment, provided in a tagging notification and so on. Regardless of how the link is communicated, when it is selected, the user interface 200 will navigate to the subsection in the workspace 240 regardless of what canvas was displayed in the user interface 200.

The collaborative workspace environment of the present disclosure also enables various individuals to comment on, edit, or otherwise provide content in one or more subsections of a workspace. Further, as one individual in the group is adding content to, deleting content from or otherwise editing a subsection of a workspace, that particular subsection may be locked such that other individuals in the group cannot change it at the same time. In some cases, the subsection is automatically locked once an induvial selects, via a received input, the particular subsection.

In yet other cases, if a subsection is associated with a tagging notification, that subsection may be locked such that only the individual or individuals that are the target of the tagging notification and/or created the tagging notification are able to edit that particular subsection. In such cases, the lock may be automatically removed once the tagging notification is received, selected, or otherwise acknowledged by the individual that is the target of the tagging notification.

In some examples, different subsections in the same workspace may be editable simultaneously by different individuals. In such cases, each subsection may be locked by individuals. In still yet other examples, some subsections may be locked during editing while others remain unlocked—even when an individual is editing that particular subsection.

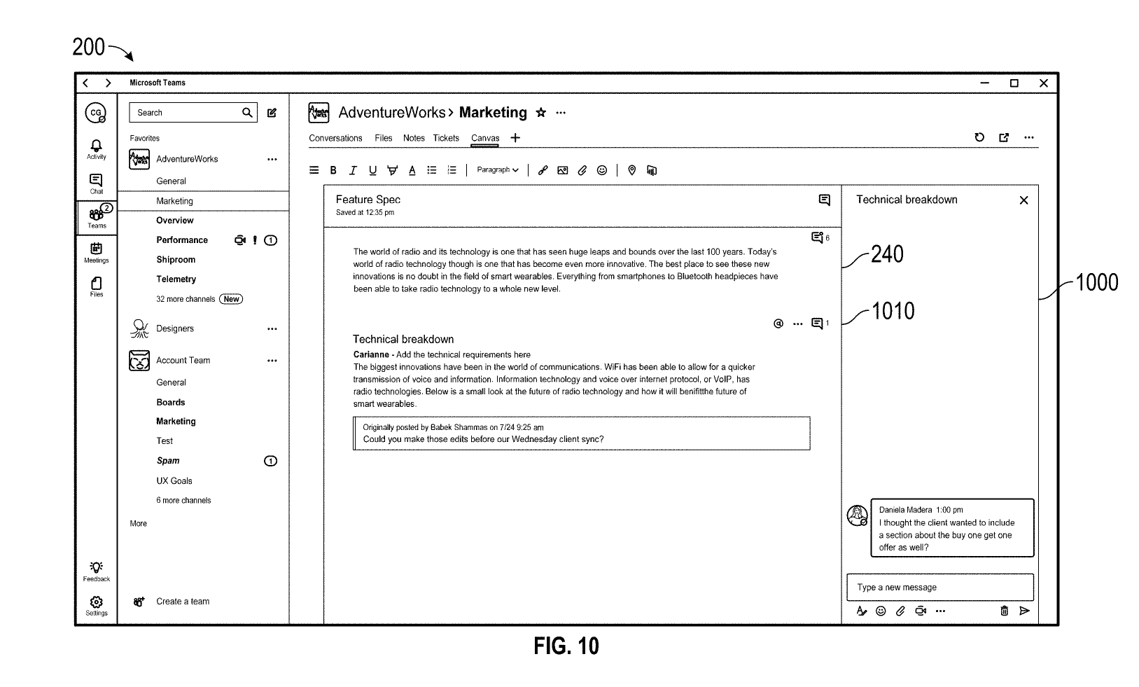

FIG. 10 illustrates some of these examples. As shown in FIG. 10, a workspace 240 may include a comments pane 1000. The comments pane may be associated with a particular subsection of the workspace 240. In such cases, any comments made about or otherwise associated with a particular subsection will only be viewable when that particular subsection is selected. In another example, the comments pane 1000 may be associated with the entire workspace 240. Thus, comments made in any subsection or otherwise associated with any subsection may be displayed in the comments pane 1000.

A comments icon 1010 may be provided on the user interface 200 and associated with a particular subsection to notify other individuals that access the workspace 240 that comments have been provided in the comments pane 1000.

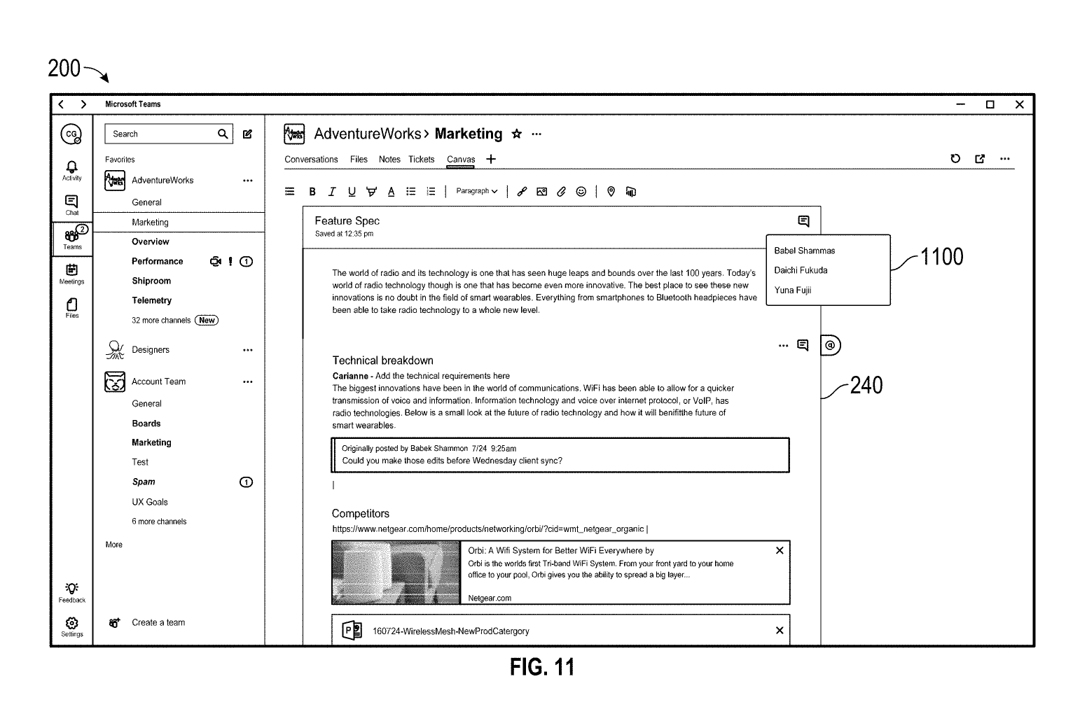

FIG. 11 illustrates a user interface of a collaborative workspace environment in which various users are accessing a workspace 240 simultaneously or substantially simultaneously. Each individual is shown or otherwise listed in a menu 1100. As described above, each individual may access, comment on, provide content for or otherwise edit different subsections of the workspace at the same time. In such cases, each subsection may be locked by different individuals such that only one user can edit the content contained in the subsection although it is still viewable by other individuals in the group.

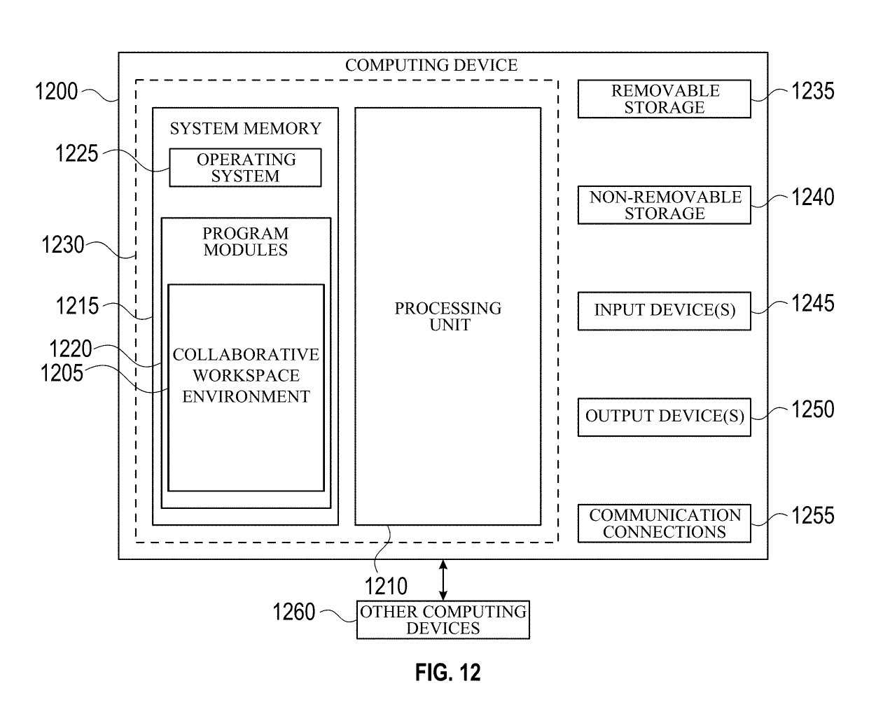

FIG. 12-FIG. 15 and the associated descriptions provide a discussion of a variety of operating environments in which aspects of the disclosure may be practiced. However, the devices and systems illustrated and discussed with respect to FIG. 12-FIG. 15 are for purposes of example and illustration and are not limiting of a vast number of electronic device configurations that may be utilized for practicing aspects of the disclosure, as described herein.

FIG. 12 is a block diagram illustrating physical components (e.g., hardware) of an electronic device 1200 with which aspects of the disclosure may be practiced. The computing device components described below may be suitable for the computing devices described above, including the client computing devices 110A and 110B and the server computing device 120.

In a basic configuration, the electronic device 1200 may include at least one processing unit 1210 and a system memory 1215. Depending on the configuration and type of electronic device, the system memory 1215 may comprise, but is not limited to, volatile storage (e.g., random access memory), non-volatile storage (e.g., read-only memory), flash memory, or any combination of such memories. The system memory 1215 may include an operating system 1225 and one or more program modules 1220 suitable for parsing received input, determining subject matter of received input, determining actions associated with the input and so on.

The operating system 1225, for example, may be suitable for controlling the operation of the electronic device 1200. Furthermore, examples of the disclosure may be practiced in conjunction with a graphics library, other operating systems, or any other application program and is not limited to any particular application or system. This basic configuration is illustrated in FIG. 12 by those components within a dashed line 1230.

The electronic device 1200 may have additional features or functionality. For example, the electronic device 1200 may also include additional data storage devices (removable and/or non-removable) such as, for example, magnetic disks, optical disks, or tape. Such additional storage is illustrated in FIG. 12 by a removable storage device 1235 and a non-removable storage device 1240.

As stated above, a number of program modules and data files may be stored in the system memory 1215. While executing on the processing unit 1210, the program modules 1220 (e.g., the content sharing module 1205) may perform processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 1200 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general purpose computer or in any other circuits or systems.

The electronic device 1200 may also have one or more input device(s) 1245 such as a keyboard, a trackpad, a mouse, a pen, a sound or voice input device, a touch, force and/or swipe input device, etc. The output device(s) 1250 such as a display, speakers, a printer, etc. may also be included. The aforementioned devices are examples and others may be used. The electronic device 1200 may include one or more communication connections 1255 allowing communications with other electronic devices 1260. Examples of suitable communication connections 1255 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 1215, the removable storage device 1235, and the non-removable storage device 1240 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 1200. Any such computer storage media may be part of the electronic device 1200. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

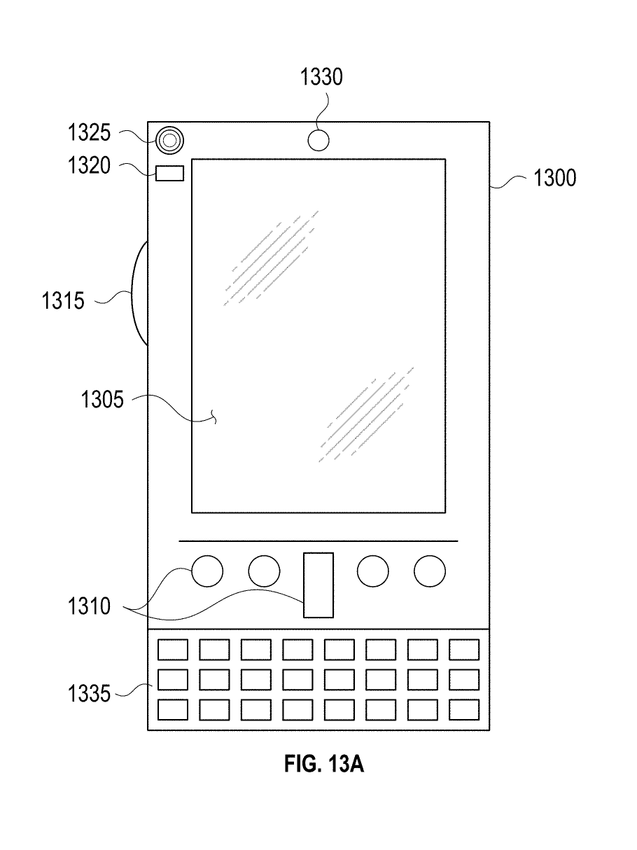

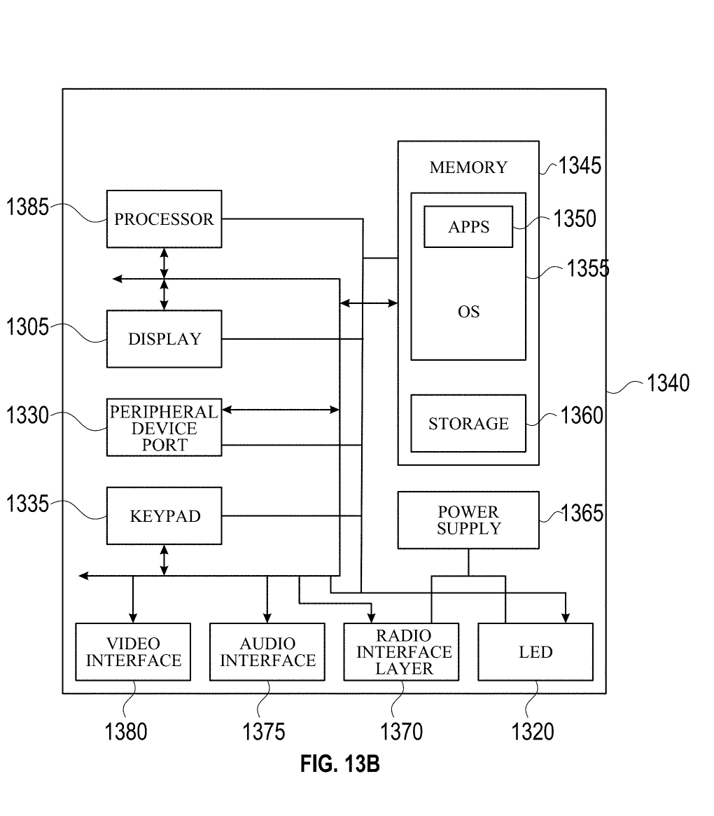

FIG. 13A and FIG. 13B illustrate a mobile electronic device 1300, for example, a mobile telephone, a smart phone, wearable computer (such as a smart watch), a tablet computer, a laptop computer, and the like, with which examples of the disclosure may be practiced. With reference to FIG. 13A, one aspect of a mobile electronic device 1300 for implementing the aspects is illustrated.

In a basic configuration, the mobile electronic device 1300 is a handheld computer having both input elements and output elements. The mobile electronic device 1300 typically includes a display 1305 and one or more input buttons 1310 that allow the user to enter information into the mobile electronic device 1300. The display 1305 of the mobile electronic device 1300 may also function as an input device (e.g., a display that accepts touch and/or force input).

If included, an optional side input element 1315 allows further user input. The side input element 1315 may be a rotary switch, a button, or any other type of manual input element. In alternative aspects, mobile electronic device 1300 may incorporate more or less input elements. For example, the display 1305 may not be a touch screen in some examples. In yet another alternative example, the mobile electronic device 1300 is a portable phone system, such as a cellular phone. The mobile electronic device 1300 may also include an optional keypad 1335. Optional keypad 1335 may be a physical keypad or a “soft” keypad generated on the touch screen display.

In various examples, the output elements include the display 1305 for showing a graphical user interface (GUI), a visual indicator 1320 (e.g., a light emitting diode), and/or an audio transducer 1325 (e.g., a speaker). In some aspects, the mobile electronic device 1300 incorporates a vibration transducer for providing the user with tactile feedback. In yet another aspect, the mobile electronic device 1300 incorporates input and/or output ports, such as an audio input (e.g., a microphone jack), an audio output (e.g., a headphone jack), and a video output (e.g., a HDMI port) for sending signals to or receiving signals from an external device.

FIG. 13B is a block diagram illustrating the architecture of one aspect of a mobile electronic device 1300. That is, the mobile electronic device 1300 can incorporate a system (e.g., an architecture) 1340 to implement some aspects. In one example, the system 1340 is implemented as a “smart phone” capable of running one or more applications (e.g., browser, e-mail, calendaring, contact managers, messaging clients, games, media clients/players, content selection and sharing applications and so on). In some aspects, the system 1340 is integrated as an electronic device, such as an integrated personal digital assistant (PDA) and wireless phone.

One or more application programs 1350 may be loaded into the memory 1345 and run on or in association with the operating system 1355. Examples of the application programs include phone dialer programs, e-mail programs, personal information management (PIM) programs, word processing programs, spreadsheet programs, Internet browser programs, messaging programs, and so forth.

The system 1340 also includes a non-volatile storage area 1360 within the memory 1345. The non-volatile storage area 1360 may be used to store persistent information that should not be lost if the system 1340 is powered down.

The application programs 1350 may use and store information in the non-volatile storage area 1360, such as email or other messages used by an email application, and the like. A synchronization application (not shown) also resides on the system 1340 and is programmed to interact with a corresponding synchronization application resident on a host computer to keep the information stored in the non-volatile storage area 1360 synchronized with corresponding information stored at the host computer.

The system 1340 has a power supply 1365, which may be implemented as one or more batteries. The power supply 1365 may further include an external power source, such as an AC adapter or a powered docking cradle that supplements or recharges the batteries.

The system 1340 may also include a radio interface layer 1370 that performs the function of transmitting and receiving radio frequency communications. The radio interface layer 1370 facilitates wireless connectivity between the system 1340 and the “outside world,” via a communications carrier or service provider. Transmissions to and from the radio interface layer 1370 are conducted under control of the operating system 1355. In other words, communications received by the radio interface layer 1370 may be disseminated to the application programs 1350 via the operating system 1355, and vice versa.

The visual indicator 1320 may be used to provide visual notifications, and/or an audio interface 1375 may be used for producing audible notifications via an audio transducer (e.g., audio transducer 1325 illustrated in FIG. 13A). In the illustrated example, the visual indicator 1320 is a light emitting diode (LED) and the audio transducer 1325 may be a speaker. These devices may be directly coupled to the power supply 1365 so that when activated, they remain on for a duration dictated by the notification mechanism even though the processor 1385 and other components might shut down for conserving battery power. The LED may be programmed to remain on indefinitely until the user takes action to indicate the powered-on status of the device.

The audio interface 1375 is used to provide audible signals to and receive audible signals from the user (e.g., voice input such as described above). For example, in addition to being coupled to the audio transducer 1325, the audio interface 1375 may also be coupled to a microphone to receive audible input, such as to facilitate a telephone conversation. In accordance with examples of the present disclosure, the microphone may also serve as an audio sensor to facilitate control of notifications, as will be described below.

The system 1340 may further include a video interface 1380 that enables an operation of peripheral device 1330 (e.g., on-board camera) to record still images, video stream, and the like.

A mobile electronic device 1300 implementing the system 1340 may have additional features or functionality. For example, the mobile electronic device 1300 may also include additional data storage devices (removable and/or non-removable) such as, magnetic disks, optical disks, or tape. Such additional storage is illustrated in FIG. 13B by the non-volatile storage area 1360.

Data/information generated or captured by the mobile electronic device 1300 and stored via the system 1340 may be stored locally on the mobile electronic device 1300, as described above, or the data may be stored on any number of storage media that may be accessed by the device via the radio interface layer 1370 or via a wired connection between the mobile electronic device 1300 and a separate electronic device associated with the mobile electronic device 1300, for example, a server computer in a distributed computing network, such as the Internet. As should be appreciated such data/information may be accessed via the mobile electronic device 1300 via the radio interface layer 1370 or via a distributed computing network. Similarly, such data/information may be readily transferred between electronic devices for storage and use according to well-known data/information transfer and storage means, including electronic mail and collaborative data/information sharing systems.

As should be appreciated, FIG. 13A and FIG. 13B are described for purposes of illustrating the present methods and systems and is not intended to limit the disclosure to a particular sequence of steps or a particular combination of hardware or software components.

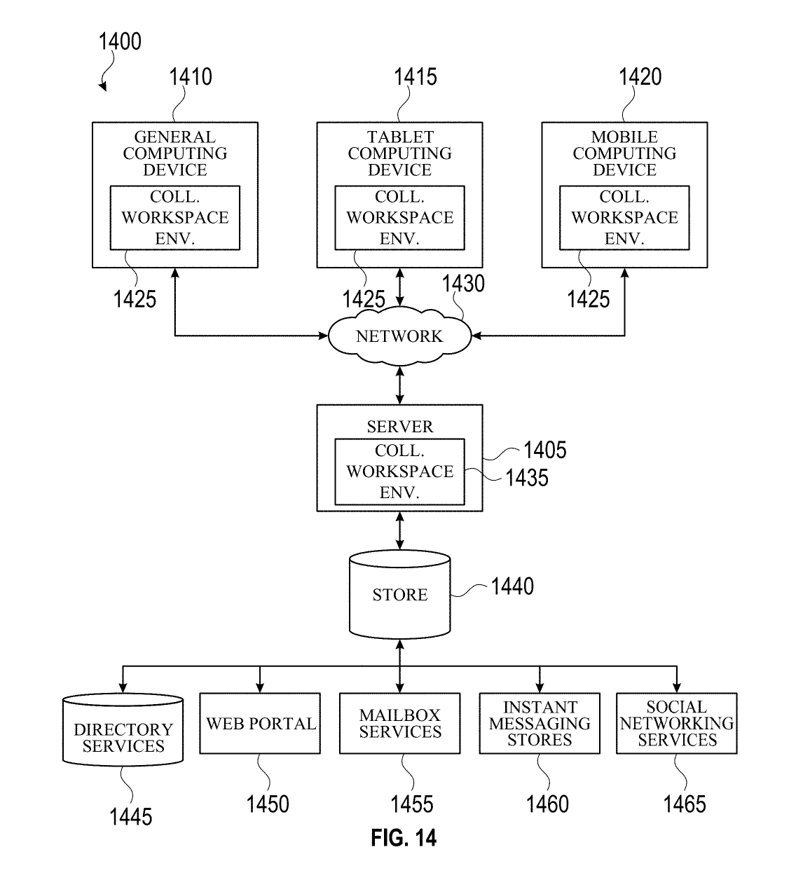

FIG. 14 illustrates one aspect of the architecture of a system 1400 such as described herein. The system may include a general electronic device 1410 (e.g., personal computer), tablet electronic device 1415, or mobile electronic device 1420, as described above. Each of these devices may include an interface for a collaborative workspace environment 1425 such as described above. For example, each device may access a network 1430 to interact with a collaborative workspace environment 1435 hosted by the server 1405.

In some aspects, the collaborative workspace environment 1435 may receive various types of information or content that is stored by the store 1440 or transmitted from a directory service 1445, a web portal 1450, mailbox services 1455, instant messaging stores 1460, or social networking services 1465.

By way of example, the aspects described above may be embodied in a general electronic device 1410 (e.g., personal computer), a tablet electronic device 1415 and/or a mobile electronic device 1420 (e.g., a smart phone). Any of these examples of the electronic devices may obtain content from or provide data to the store 1440.

As should be appreciated, FIG. 14 is described for purposes of illustrating the present methods and systems and is not intended to limit the disclosure to a particular sequence of steps or a particular combination of hardware or software components.

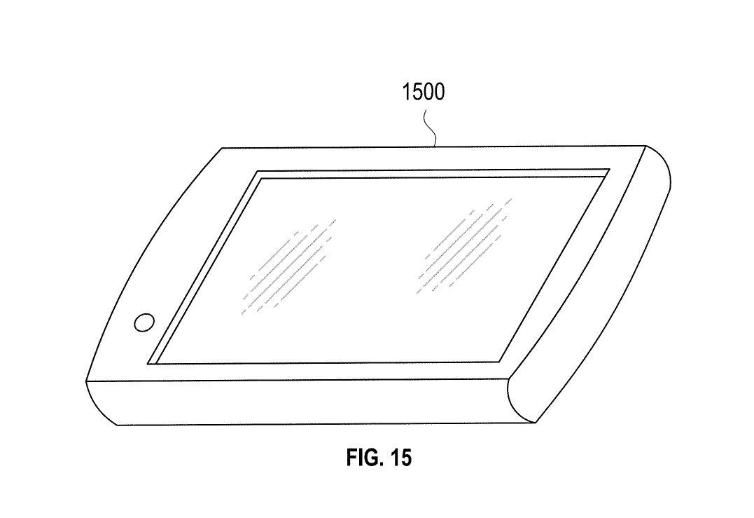

FIG. 15 illustrates an example tablet electronic device 1500 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices.

For example, user interfaces and information of various types may be displayed and interacted with on a wall surface onto which user interfaces and information of various types are projected. Interaction with the multitude of computing systems with which examples of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 15 is described for purposes of illustrating the present methods and systems and is not intended to limit the disclosure to a particular sequence of steps or a particular combination of hardware or software components.

In addition to the examples described above, also described is a system comprising: at least one processing unit; and at least one memory storing computer executable instructions which, when executed by the at least one processing unit, cause the system to provide a user interface for a collaborative workspace environment, the user interface comprising: a first canvas associated with an entity provided by a service in a collaborative workspace environment; a set of commenting tools that enable comments to be provided about the entity; and a second canvas for displaying a representation of the entity and for providing a conversation area for the entity; wherein comments made in the first canvas are reflected in the conversation area of the second canvas and wherein comments made in the conversation area of the second canvas are reflected in the first canvas. In other examples, the system further comprises instructions for causing the user interface to display the first canvas when the representation is selected. In other examples, the conversation area in the second canvas displays comments about the entity. In other examples, the second canvas includes a second representation that is associated with a second entity, wherein the second entity is associated with a third canvas in the user interface. In other examples, the a conversation pane is associated with the first canvas, wherein the conversation pane displays comments associated with the entity. In other examples, the system further comprises instructions for providing access to the entity when at least a portion of the comments made in the first canvas or the second canvas is selected.

Also disclosed is a method for displaying input associated with an entity in a collaborative workspace environment, comprising: receiving input in a conversation pane of a first canvas in a user interface of the collaborative workspace environment, wherein the canvas is associated with a particular context; displaying the input in the conversation pane; generating a representation of the input; receiving a selection of a second canvas in the collaborative workspace environment; and displaying the representation in the second canvas. In other examples, the method further comprises: receiving additional input in an input area associated with the representation; and displaying the additional input in the representation. In other examples, the method further comprises adding the additional input to the conversation pane of the first canvas. In other examples, the second canvas displays a plurality of representations, wherein each representation is associated with a different canvas. In other examples, the method further comprises: receiving a selection of the representation; and displaying the first canvas in the user interface of the collaborative workspace environment. In other examples, the second canvas displays input associated with two or more contexts. In other examples, the input is provided in a conversation pane contained within the entity.

Also described is a computer-readable storage medium encoding computer executable instructions which, when executed by a processing unit, generates a user interface, the user interface comprising: a first canvas having a conversation pane in which input, associated with an entity, is provided; and a second canvas for displaying a representation of the input received in the first canvas; wherein input received in the first canvas is reflected in the representation of the second canvas and wherein input received in the second canvas and associated with the representation is reflected in the first canvas. In other examples, the computer-readable storage further comprises instructions for displaying the second canvas in response to received input. In other examples, the computer-readable storage further comprises displaying the first canvas when the representation is selected. In other examples, the second canvas displays a plurality of representations, wherein each representation of the plurality of representations is associated with a different entity. In other examples, each entity of the different entities is associated with a different canvas. In other examples, the computer-readable storage further comprises instructions for providing access to the entity when at least a portion of the representation is selected. In some examples, the second canvas comprises a conversation area configured to receive the input associated with the representation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
at least one processing unit; and
at least one memory storing computer executable instructions that, when executed by the at least one processing unit, cause the system to perform a method, comprising:
displaying a first canvas associated with an entity, the first canvas hosting a document that is dividable into subsections;
adding a subsection to the document in response to a received input;
adding content to the subsection of the document;
associating a tagging notification to the subsection of the document, wherein the tagging notification identifies an individual that has access to the document in the collaborative workspace environment;
providing the tagging notification on a second canvas in the collaborative workspace environment; and
providing a notification of the tagging notification to the individual.

2. The system of claim 1, wherein the tagging notification includes text content.

3. The system of claim 1, further comprising instructions for locking the subsection of the document in response to a received input, wherein locking the subsection of the document prevents the subsection of the document from being edited by individuals, other than the individual that provided the input, that access the document in the collaborative workspace environment.

4. The system of claim 1, further comprising instructions for displaying the second canvas in response to received input.

5. The system of claim 4, further comprising instructions for displaying the subsection of the document in the first canvas when the tagging notification on the second canvas is selected.

6. The system of claim 1, further comprising instructions for generating a link to the subsection of the document.

7. The system of claim 6, further comprising instructions for providing the link on the second canvas.

8. A method, comprising:
displaying a first canvas on a user interface of a computing device, wherein the first canvas is associated with an entity and hosts a document that is dividable into subsections;
adding a subsection to the document in response to a received input;
adding content to the subsection of the document in response to additional received input;
associating a tagging notification to the subsection of the document, wherein the tagging notification is directed to an individual that has access to the subsection of the document in the collaborative workspace environment;
displaying the tagging notification on a second canvas in the collaborative workspace environment; and
providing a notification of the tagging notification to the individual.

9. The method of claim 8, wherein the tagging notification is associated with an electronic communication.

10. The method of claim 8, further comprising locking the subsection of the document in response to received input.

11. The method of claim 10, wherein locking the subsection of the document prevents the subsection of the document from being edited by anyone other than the individual that provided the received input to add the subsection to the document.

12. The method of claim 10, wherein locking the subsection of the document prevents the subsection of the document from being edited by anyone other than the individual that is associated with the tagging notification.

13. The method of claim 8, further comprising displaying the second canvas in the user interface in response to received input.

14. The method of claim 13, further comprising displaying the subsection of the document in the first canvas in the user interface when the tagging notification on the second canvas is selected.

15. The method of claim 8, further comprising generating a link to the subsection of the document.

16. The method of claim 15, further comprising providing the link on the second canvas when the second canvas is displayed on the user interface.

17. A system, comprising:
at least one processing unit; and
at least one memory storing computer executable instructions that, when executed by the at least one processing unit, cause the system to perform a method, comprising:
displaying a canvas associated with an entity in a user interface of a collaborative workspace environment;
creating a workspace in the canvas in response to received input;
adding a subsection to the workspace in response to received input;
generating a tagging notification that identifies an individual that has access to the workspace;
associating the tagging notification with the subsection;
providing the tagging notification on a second canvas in the user interface; and
providing a notification of the tagging notification to the individual.

18. The system of claim 17, further comprising instructions for receiving content that is associated with the tagging notification.

19. The system of claim 18, further comprising instructions for providing the content on the second canvas.

20. The system of claim 17, further comprising instructions for automatically locking the subsection when the tagging notification is associated with the subsection.
